(19) United States
(12) Patent Application Publication
(10) Pub. No.: US 2008/0222575 A1
(43) Pub. Date: Sep. 11, 2008

(54) Device Comprising a Detector for Detecting an Uninterrupted Looping Movement

(75) Inventors: Gerrit Hollemans, Eindhoven (NL); Sander Bernard Francis Van De Wijdeven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,958

(22) PCT Filed: Sep. 22, 2006
(86) PCT No.: PCT/IB06/53440

§ 371 Date: Mar. 25, 2008

(30) Foreign Application Priority Data
Sep. 26, 2005 (EP) 05108837.5

(51) Int. Cl. G06F 3/048

(52) U.S. Cl. 715/863

(57) ABSTRACT

Devices (1) comprising detectors (4) for detecting uninterrupted looping movements are provided with processors (6) for in response to detections of parts of uninterrupted looping movements (21-23) performing first functions (31,32,35) or second functions (33,34,36,37,38) to be selected in dependence of pre-indication signals, to improve an efficiency of the devices (1) and to increase their possibilities. The first functions comprise scrolling functions in first directions and the second functions comprise scrolling functions in different second directions. The pre-indication signals may originate from further generators (7), or the detectors (4) are arranged to further detect further movements (24-27) and the generators (41)—that are already used for in response to the detections of the parts of the uninterrupted looping movements (21-23) generating indication signals destined for the processor (6) and defining durations and speeds of the parts of the uninterrupted looping movements (21-23)—are further arranged to, in response to detections of the further movements (24-27), generate the pre-indication signals.

The invention relates to a device comprising a detector for detecting uninterrupted looping movements, and also relates to a detector, to a generator, to a processor, to an element, to a method, to a computer program product, and to a medium comprising a computer program product, all for use in (combination with) a device.

Examples of such a device are consumer products such as audio players, video players, laptops and desktops, parts of consumer products such as user interfaces and man-machine interfaces, and non-consumer products and parts thereof.

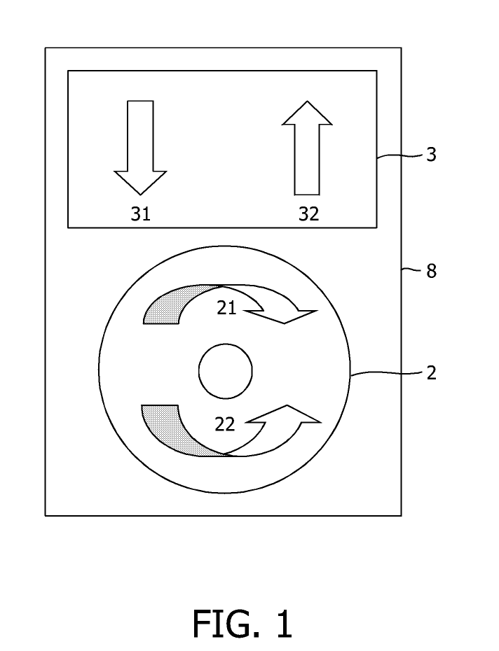

A prior art device is known from US2004/0224638 A1, which discloses in its FIG. 1 a media player comprising a touch pad and a sensor arrangement beneath the touch pad. This sensor arrangement forms a detector for detecting uninterrupted looping movements. The uninterrupted looping movements are advantageous in that a user can for example scroll entire documents and entire menus without taking a finger from the touch pad. Compared to using a mouse with a scrolling wheel that requires several interrupted movements of the scrolling wheel to scroll entire documents and entire menus, the use of the uninterrupted looping movements make the device more user friendly.

The known device is disadvantageous, inter alia, owing to the fact that the uninterrupted looping movements are used for relatively few functions and that these uninterrupted looping movements require a touch pad with a relatively large area. Making clockwise loops for example results in scrolling down, and making anti-clockwise loops for example results in scrolling up. So, the uninterrupted looping movements are used for scrolling up/down, and the touch pad with the relatively large area is used relatively inefficiently. As a result, the prior art device is a relatively inefficient device.

It is an object of the invention, inter alia, to provide a relatively efficient device comprising a detector for detecting uninterrupted looping movements.

Further objects of the invention are, inter alia, to provide a detector, a generator, a processor, an element, a method, a computer program product, and a medium comprising a computer program product all for use in (combination with) a relatively efficient device.

The device according to the invention comprises

a detector (4) for detecting an uninterrupted looping movement (21-23), and

a processor (6) for, in response to a detection of at least a part of the uninterrupted looping movement (21-23), generating a pre-indication signal on the basis of the at least the part of the uninterrupted looping movement, and performing at least a first function (31,32,35) or a second function (33,34,36,37,38) to be selected in dependence of a pre-indication signal, the first and second functions (31-38) being different functions.

By introducing at least two different functions and by selecting at least one of them in dependence of a pre-indication signal, the uninterrupted looping movements are used for more than one purpose. The first function for example comprises an up/down scrolling function of an image and the second function for example comprises an in/out zooming function with respect to an image, without other functions being excluded. As a result, the device according to the invention is relatively efficient.

The device according to the invention is further advantageous, inter alia, in that it offers more possibilities to a user.

The fact that the detector can detect uninterrupted looping movements does not exclude that such a detector may also be able to detect non-uninterrupted movements or non-looping movements. So, the detector detects uninterrupted looping movements and parts thereof. A performance of at least the first function and the second function does not exclude that a collection of different functions comprises a third function etc. and does not exclude that two or more functions are performed simultaneously. A looping movement follows or passes through a loop that may have any angular and/or non-angular shape.

An embodiment of the device according to the invention is defined by the first function comprising a scrolling function in a first direction and the second function comprising a scrolling function in a second direction, the first and second directions being non-parallel directions. The first direction for example comprises an up/down direction or a y-direction, and the second direction for example comprises a left/right direction or a x-direction.

An embodiment of the device according to the invention is defined by further comprising

a generator for in response to the detection of at least the part of the uninterrupted looping movement generating an indication signal destined for the processor.

The generator converts a detection of at least the part of the uninterrupted looping movement into an indication signal and the processor performs the first or the second function, in response to the indication signal from a direct point of view and in response to the detection of at least the part of the uninterrupted looping movement from an indirect point of view.

An embodiment of the device according to the invention is defined by the indication signal defining a duration and a speed of the part of the uninterrupted looping movement, a duration of the first and second functions being related to the duration of the part of the uninterrupted looping movement, and a speed of the first and second functions being related to the speed of the part of the uninterrupted looping movement. The fact that the duration and the speed of the first and second functions on the one hand and the part of the uninterrupted looping movement on the other hand are related allows a user to fully control the first and second functions, which is a great advantage.

An embodiment of the device according to the invention is defined by the device further comprising

a further generator for generating the pre-indication signal, the generator and the further generator being different generators.

The use of different generators for generating the indication signal and the pre-indication signal allows both generations to be performed simultaneously.

An embodiment of the device according to the invention is defined by the detector being arranged to further detect a further movement and the generator being arranged to, in response to a detection of the further movement, further generate the pre-indication signal, the part of the uninterrupted looping movement and the further movement being different movements. The use of the same detector for detecting different movements and the use of the same generator for generating the indication signal and the pre-indication signal gives the device according to the invention a further increased efficiency. The detection of the further movement defines the purpose of the following (part of the) uninterrupted looping movement, which is a great advantage. This allows a user for example to make a further movement in an up or down direction, in response to which a following (part of an) uninterrupted looping movement results in scrolling up or down, and allows a user for example to make a further movement in a left or right direction, in response to which a following (part of an) uninterrupted looping movement results in scrolling left or right.

It is to be noted that the different movements may be distinct parts and/or at least distinguishable parts of a single gesture such as for example a single compound gesture, without departing from the scope of this invention.

An embodiment of the device according to the invention is defined by the uninterrupted looping movements being clutch less movements that start at starting positions of loops and that pass through these loops. Clutch less movements are movements whereby a user does not need to lift a finger or a pointer when moving in the form of one or more loops. The loops may be arbitrary loops.

An embodiment of the device according to the invention is defined by the detector comprising an element for receiving the uninterrupted looping movements via a finger or a pointer in a mechanical way or a resistive way or a capacitive way or an inductive way. A reception of an uninterrupted looping movement or a part thereof in a mechanical way uses a mechanical construction such as a rotating wheel etc. A reception of an uninterrupted looping movement or a part thereof in a resistive way or a capacitive way or an inductive way uses a sensitive construction for sensing (a change in) a resistance or a capacity or an inductivity.

An embodiment of the device according to the invention is defined by the element comprising movement guiding means. Such movement guiding means for example comprise one or more grooves and/or one or more edges for guiding an input from a user such as (a part of) an uninterrupted looping movement and/or a further movement.

US 2004/0174336 A1 discloses a scroll wheel assembly for scrolling an image in multiple directions. A scroll wheel is turned for scrolling in a first dimension and the scroll wheel is pivoted for scrolling in a second dimension. This scroll wheel assembly is a disadvantageously complex mechanical construction. US 2004/0207648 discloses multidimensional movements in a display window. These multidimensional movements are made in response to pointing at certain parts of the window and require a cursor to be located on these certain parts in a disadvantageously precise way. EP 1 182 606 A2 discloses a mouse with an optical sensor in place of a scroll wheel. This optical sensor detects an x-movement or a y-movement and in response scrolls in an x-direction or a y-direction, whereby a user is obliged to clutch (make a movement, stop this movement, lift a hand or a finger, go back to a start position, lower the hand or the finger, and repeat the movement etc.). GB 2 237 486 A discloses the controlling of computer displays by using a two dimensional scroll palette, whereby a content and a size of a first window are controlled via two-dimensional movements of a cursor in a second window. This requires a cursor to be located in this second window in a disadvantageously precise way. None of these prior art documents discloses uninterrupted looping movements and non of these prior art documents is based on such uninterrupted looping movements.

Embodiments of the detector according to the invention and of the generator according to the invention and of the processor according to the invention and of the element according to the invention and of the method according to the invention and of the computer program product according to the invention and of the medium according to the invention correspond with the embodiments of the device according to the invention, as far as relevant. The computer program product according to the invention may be run via the processor according to the invention and the medium according to the invention may form part of or may be coupled to the processor according to the invention. The detector according to the invention and/or the generator according to the invention and/or the processor according to the invention and/or the element according to the invention may be produced and/or sold separately from a rest of the device according to the invention.

The invention is based upon an insight, inter alia, that uninterrupted looping movements can be used for more than one purpose, and is based upon a basic idea, inter alia, that in response to a detection of at least a part of an uninterrupted looping movement at least one function selected from at least two functions in dependence of a pre-indication signal is to be performed.

The invention solves the problem, inter alia, to provide a relatively efficient device comprising a detector for detecting uninterrupted looping movements, and is further advantageous, inter alia, in that it offers more possibilities to a user.

These and other aspects of the invention will be apparent from and elucidated with reference to the embodiments(s) described hereinafter.

In the drawings:

FIG. 1 shows diagrammatically an outer side of a prior art device whereby parts of uninterrupted looping movements result in one function being performed,

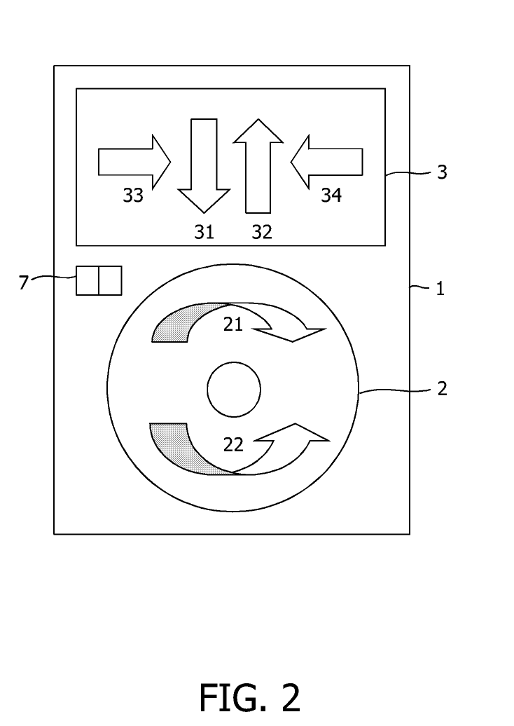

FIG. 2 shows diagrammatically an outer side of an embodiment of a device according to the invention whereby parts of uninterrupted looping movements result in different functions being performed,

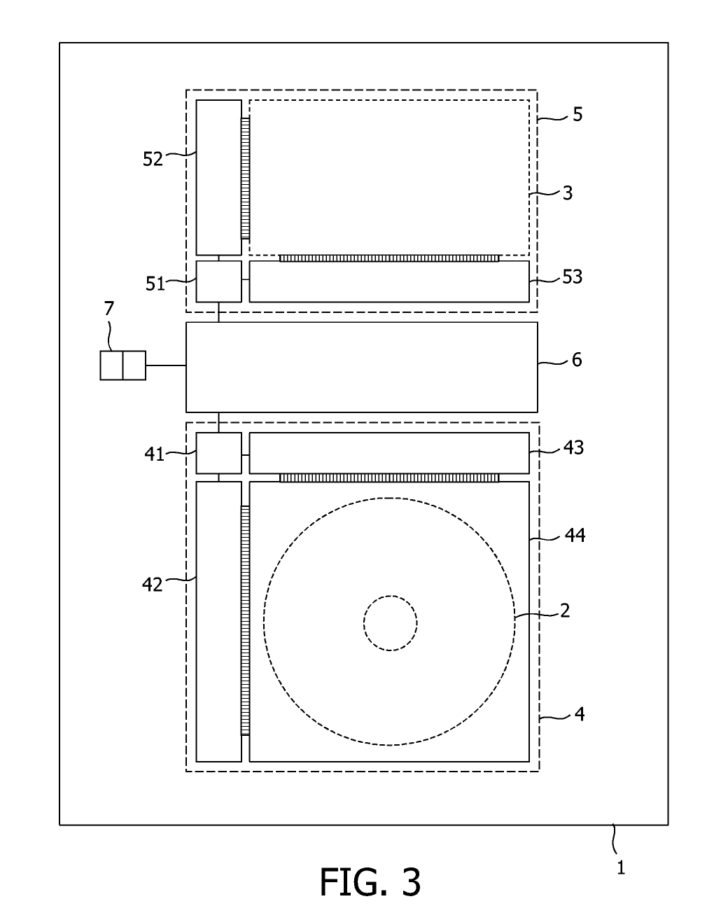

FIG. 3 shows diagrammatically an inner side of an embodiment of a device according to the invention,

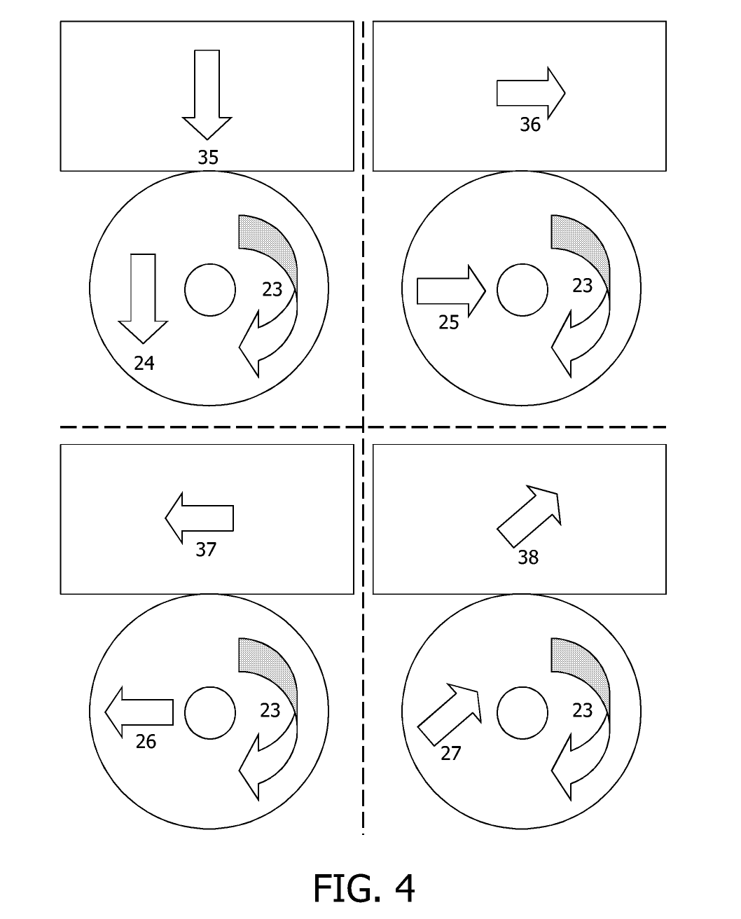

FIG. 4 shows parts of uninterrupted looping movements and further movements resulting in different functions being performed,

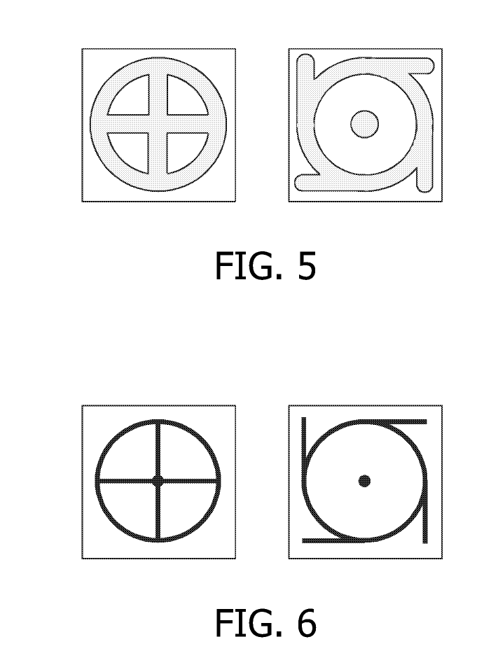

FIG. 5 shows a touch pad with guiding means in the form of grooves for guiding an input, and

FIG. 6 shows a touch pad with guiding means in the form of edges for guiding an input.

The prior art device 8 shown in FIG. 1 comprises an element 2 for receiving uninterrupted looping movements 21,22 and parts thereof and comprises e.g. a display 3 for displaying an image. In response to a reception (detection) of at least a part of an uninterrupted looping movement 21,22, a function 31,32 is performed, such as scrolling the image in a vertical direction, whereby a clockwise (part of an) uninterrupted looping movement 21 for example results in scrolling down and an anti-clockwise (part of an) uninterrupted looping movement 22 for example results in scrolling up.

The device 1 according to the invention shown in FIG. 2 comprises an element 2 for receiving uninterrupted looping movements 21,22 and parts thereof and comprises e.g. a display 3 for displaying an image. In response to a reception (detection) of at least a part of an uninterrupted looping movement 21,22, for example a first function 31,32 is performed, such as scrolling the image in a vertical direction, whereby a clockwise (part of an) uninterrupted looping movement 21 for example results in scrolling down and an anti-clockwise (part of an) uninterrupted looping movement 22 for example results in scrolling up, and/or for example a second function 33,34 is performed, such as scrolling the image in a horizontal direction, whereby a clockwise (part of an) uninterrupted looping movement 21 for example results in scrolling right and an anti-clockwise (part of an) uninterrupted looping movement 22 for example results in scrolling left. The device 1 further comprises a further generator 7 such as for example a switch or a button for generating a pre-indication signal. This pre-indication signal defines whether the first function 31,32 or the second function 33,34 is to be performed. Other functions such as zooming in/out etc. and/or other combinations of functions such as scrolling up/down and zooming in/out or such as zooming in/out and scrolling left/right etc. are not to be excluded.

The device 1 according to the invention shown in FIG. 3 comprises a detector 4 coupled to (or connected to) the element 2 for detecting uninterrupted looping movements 21,22 and parts thereof and comprises e.g. a display unit 5 and a processor 6 and a further generator 7 such as a switch or a button. The detector 4 comprises a sensor 44 coupled to (or connected to) two sensor drivers 42,43 which are coupled to (or connected to) a sensor controller or generator 41. The display unit 5 comprises a display controller 51 coupled to (or connected to) two display drivers 52,53. The processor 6 is coupled to (or connected to) the sensor controller or generator 41 and to the display controller 51 for in response to a detection of at least a part of an uninterrupted looping movement 21,22 performing at least a first function 31,32 or a second function 33,34 to be selected in dependence of a pre-indication signal, with the first and second functions 31-34 being different functions.

The processor 6 is adapted, for example, to separate a direction indicating stroke from a circular motion of a finger or a pointer on the element 2. The direction indicating stroke and the circular motion may form a single uninterrupted movement which may be in the looping or another form convenient for use on the element 2. The direction indicating stroke may be translated into the preselection signal which allows to select the first or the second function. The circular motion may indicate a distance of scrolling in a music playlist.

The sensor controller or generator 41 for example generates in response to the detection of at least the part of the uninterrupted looping movement 21,22 an indication signal destined for the processor 6. This indication signal for example defines a duration and a speed of the part of the uninterrupted looping movement 21,22. A duration of the first and second functions may be related (for example: may be equal to) the duration of the part of the uninterrupted looping movement 21,22. A speed of the first and second functions may be related to (for example: may be equal to or may be proportional to) the speed of the part of the uninterrupted looping movement 21,22.

A combination of the element 2 and the detector 4 may be considered to be a user interface such as a graphical user interface and may be considered to a man-machine interface such as a graphical man-machine interface. When comprising the display 3, the device 1 may be a consumer product such as an audio player, a video player, a laptop and a desktop, or a non-consumer product. When not comprising the display 3, the device 1 may be a part of a consumer product such as a user interface or a man-machine interface, or a part of a non-consumer product.

In case the further generator 7 is used for generating the pre-indication signal, the indication signal and the pre-indication signal may be generated simultaneously. However, the further generator 7 requires a user to either use two hands simultaneously or to use one hand or one finger subsequently for both different generations.

FIG. 4 shows parts of uninterrupted looping movements and further movements resulting in different functions being performed, to avoid the further generator 7. To do so, the detector 4 is arranged to further detect a further movement 24-27 and the generator 41 is arranged to, in response to a detection of the further movement 24-27, further generate the pre-indication signal, with the part of the uninterrupted looping movement 21-23 and the further movement 24-27 being different movements. In FIG. 4, compared to FIG. 2, in each corner only the display 3 and the element 2 are shown.

As shown in FIG. 4 left upper corner, a further movement 24 in a down direction defines that the (part of the) uninterrupted looping movement 23 results in a first function 35 in the form of scrolling an image in a down direction.

As shown in FIG. 4 right upper corner, a further movement 25 in a right direction defines that the (part of the) uninterrupted looping movement 23 results in a second function 36 in the form of scrolling an image in a right direction.

As shown in FIG. 4 left lower corner, a further movement 26 in a left direction defines that the (part of the) uninterrupted looping movement 23 results in a second function 37 in the form of scrolling an image in a left direction.

In FIG. 4 right upper corner and left lower corner, the same clockwise (part of the) uninterrupted looping movement 23 results in scrolling an image in a right direction and in a left direction. Of course, alternatively, this might be achieved by for example a further movement in an arbitrary horizontal direction in combination with (a part of) an uninterrupted looping movement in a clockwise or anti-clockwise direction.

As shown in FIG. 4 right lower corner, a further movement 27 in a diagonal from left to right rising direction defines that the (part of the) uninterrupted looping movement 23 results in a second function 38 in the form of scrolling an image in a diagonal from left to right rising direction.

Other further movements are not to be excluded, such as further movements in other directions, further movements not in the form of straight lines, combinations of further movements and further movements in the form of touches or contacts in a location-dependent or a location-independent way etc.

The element 2 receives the uninterrupted looping movements 21-23 via a finger or a pointer in a mechanical way, in which case the element 2 for example comprises (a part of) a wheel coupled via an axis to the detector 4 now provided with a sensor not shown for detecting (parts of) rotations of the axis. This mechanical embodiment is preferably used in combination with the further generator 7. Or the element 2 receives the uninterrupted looping movements 21-23 via a finger or a pointer a resistive way or a capacitive way or an inductive way, in which case the element 2 for example comprises a touch pad coupled to the sensor 44 for detecting the touch pad being touched by a finger or a pointer. This resistive or capacitive or inductive embodiment is preferably used in combination with the further movements 24-27. The different movements 21-27 may be distinct parts and/or at least distinguishable parts of a single gesture such as for example a single compound gesture.

In FIG. 5, in the left drawing, a touch pad with grooves is shown for guiding an input such as an inputted gesture. In the right drawing, for example four single compound gestures are shown each comprising a horizontal or vertical starting part (a further movement) followed by a looping part (such as a (part of a) looping movement). The grooves guide a user.

In FIG. 6, in the left drawing, a touch pad with edges is shown for guiding an input such as an inputted gesture. In the right drawing, for example four single compound gestures are shown each comprising a horizontal or vertical starting part (a further movement) followed by a looping part (such as a (part of a) looping movement). The edges guide a user.

The grooves and edges are embodiments of guiding means for guiding an input from a user, without excluding other embodiments, such as partly smooth and partly rough surfaces etc. Alternatively to the grooves or edges, the movement guiding means may comprise a visual guiding means such one or more strips of LEDs for indicating possible gestures and how a user may carry out e.g. the uninterrupted movement comprising the direction indicating gesture and the circular motion. The processor 6 may comprise or may be coupled to (or connected to) a medium such as a memory for storing a computer program product for use in (combination with) the device 1.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Device (1) comprising
a detector (4) for detecting an uninterrupted looping movement (21-23), and
a processor (6) for, in response to a detection of at least a part of the uninterrupted looping movement (21-23), generating a pre-indication signal on the basis of the at least the part of the uninterrupted looping movement, and performing at least a first function (31,32,35) or a second function (33,34,36,37,38) to be selected in dependence of a pre-indication signal, the first and second functions (31-38) being different functions.

2. Device (1) according to claim 1, the first function (31,32,35) comprising a scrolling function in a first direction, and the second function (33,34,36,37,38) comprising a scrolling function in a second direction, the first and second directions (31-38) being non-parallel directions.

3. Device (1) according to claim 1, further comprising
a generator (41) for, in response to the detection of at least the part of the uninterrupted looping movement (21-23), generating an indication signal destined for the processor (6).

4. Device (1) according to claim 3, the indication signal defining a duration and a speed of the part of the uninterrupted looping movement (21-23), a duration of the first and second functions being related to the duration of the part of the uninterrupted looping movement (21-23), and a speed of the first and second functions being related to the speed of the part of the uninterrupted looping movement (21-23).

5. Device (1) according to claim 3, the device (1) further comprising
a further generator (7) for generating the pre-indication signal, the generator (41) and the further generator (7) being different generators.

6. Device (1) according to claim 3, the detector (4) being arranged to further detect a further movement (24-27) and the generator (41) being arranged to, in response to a detection of the further movement (24-27), further generate the pre-indication signal, the part of the uninterrupted looping movement (21-23) and the further movement (24-27) being different movements.

7. Device (1) according to claim 1, the uninterrupted looping movements (21-23) being clutch less movements that start at starting positions of loops and that pass through these loops.

8. Device (1) according to claim 1, the detector (4) comprising an element (2) for receiving the uninterrupted looping movements via a finger or a pointer in a mechanical way or a resistive way or a capacitive way or an inductive way.

9. Device (1) according to claim 8, the element (2) comprising movement guiding means.

10. Detector (4) for use in a device (1) as defined in claim 6.

11. Generator (41) for use in a device (1) as defined in claim 6.

12. Processor (6) for use in a device (1) as defined in claim 1.

13. Element (2) for use in a device (1) as defined in claim 9.

14. Method for use in a device (1) and comprising
a detecting step for detecting an uninterrupted looping movement (21-23), and
a performing step for, in response to a detection of at least a part of the uninterrupted looping movement (21-23), generating a pre-indication signal on the basis of the at least the part of the uninterrupted looping movement, and performing at least a first function (31,32,35) or a second function (33,34,36,37,38) to be selected in dependence of a pre-indication signal, the first and second functions (31-38) being different functions.

15. Computer program product for use in a device (1) and comprising
a detecting function for detecting an uninterrupted looping movement (21-23), and
a performing function for, in response to a detection of at least a part of the uninterrupted looping movement (21-23), generating a pre-indication signal on the basis of the at least the part of the uninterrupted looping movement, and performing at least a first function (31,32,35) or a second function (33,34,36,37,38) to be selected in dependence of a pre-indication signal, the first and second functions (31-38) being different functions.

16. Medium comprising the computer program product as defined in claim 15.
